(19) United States
(12) Patent Application Publication
(10) Pub. No.: US 2012/0186782 A1
(43) Pub. Date: Jul. 26, 2012

(54) BEER CHILLING DEVICE

(76) Inventor: Andrew J. Nauta, Stouffville (CA)

(21) Appl. No.: 13/261,224

(22) PCT Filed: Oct. 19, 2010
(86) PCT No.: PCT/CA2010/001665

§ 371 Date: Mar. 22, 2012

Related U.S. Application Data
(60) Provisional application No. 61/279,580, filed on Oct. 23, 2009.

(51) Int. Cl. F28D 15/00; B23P 15/26

(52) U.S. Cl. 165/104.13; 165/104.11; 165/104.19; 29/890.03

(57) ABSTRACT

An elongated heat exchanger of generally tubular shape in which at least one heat exchanger is mounted in the interior thereof. The heat exchanger is composed of an outer tube which may be of a plastic material which forms a sealed chamber and has a pair of ends from which spigots extend. A heat exchanger is mounted within the outer tube and is connected to the spigots at each end so that it extends the length of the outer tube and is sealedly connected to each spigot. The heat exchanger consists of a number of stainless steel tubes (greater than two) each having the same diameter and gently twisted together to form a single heat exchanger. The spigots located at each end of the outer tube thus form manifolds for the tubes of the heat exchanger.

A heat exchanger fluid is introduced in the space between the outer tube and the heat exchanger to provide the necessary exchange of heat in the device. Because the heat exchanger is connected by manifolds of the same end spigot, each tube of the heat exchanger carries the same product.

This application relates to a heat exchanger for almost any liquid (hot or cold) but is primarily intended for chilling beer before it is dispensed at a fountain. Beer as it is known, is a product of fermentation (usually barley) and after many processes are performed on this product of fermentation, it is bottled or shipped in kegs (under pressure) to the public for consumption.

It is the serving of beer from kegs that this application is directed, and it is primarily to the chilling of beer just before it is served that this application is directed.

The general qualities of beer are as follows:

Beer, shipped in kegs, is kept under pressure using carbon dioxide. The solubility of carbon dioxide in beer varies with temperature and pressure. The solubility of carbon dioxide increases in beer until it reaches a maximum at the freezing point of the liquid beer (about 28.3° F.).

The solubility of carbon dioxide in liquid beer decreases with decreasing pressure on the beer.

Beer, shipped in kegs usually is pressurized with carbon dioxide and is generally stored in a “cold room”of the beer establishment. The “cold room” is usually maintained at about 40° F. Beer is dispensed from kegs by special lines attached to each keg. Propellants are generally supplied to each keg which may include carbon dioxide, nitrogen, air, or combinations of these gasses. Beer pumps may be also included to increase the pressure on the beer being delivered to the dispensing fountain.

The distance between the “cold room” where the kegs are stored and the beer dispensing fountain may be up to and beyond 100 feet. Prior art systems used a heat transfer apparatus, generally called a trunk line, comprising an inner tube (metal or plastic) extending from the “cold room” to the fountain. Beer was carried in this tube and cold glycol (not harmful if ingested) was circulated inside the This tube was generally enclosed in an outside pipe which was composed of a plastic or metallic substance and was separated from the inner tube by means of a plastic or similar insulation. The whole of the outside pipe and inner tube was somewhat flexible.

It was not unusual to have several individual inner tubes carrying beer of different kinds located inside the outer sheath but in no instance was beer of the same type carried by more than one tube to the same destination.

The trunk line configuration was an attempt to prevent warmed beer being served at the fountain. While beer served at the fountain was partially warmed during transport from the cold room, every attempt was made to serve beer at the fountain which was at the temperature of beer stored in the cold room.

Additional cooling of beer being served was often attempted at the fountain. A beer accumulator (reservoir) may be added to the system to help create a more even temperature of the served beer. Sometimes a “plate cooler” was added at the fountain to assure that the dispensed beer was cooled sufficiently. Using this system beer was generally dispensed at 29°-32° F. at the fountain.

Periods of high demand for beer sometimes exceeded the ability of the system to supply cold beer, with the result being that beer was dispensed at a temperature that exceeded the desired range. The result of the existence of high temperature beer being served was:

1. General customer dissatisfaction due to being served beer that was not sufficiently chilled, and

2. Excessive foaming of the beer in the system, tending to lead to the “freeze up” of the beer conveyor system, which could lead to the shut down of the entire beer conveyer system.

The improvement brought about by the system of this invention seeks to provide the following improvements. The temperature at which the beer is served is more accurately controlled at a colder temperature than previously. The driving pressure on the cold beer is not increased by the apparatus of this invention. The “cold room” now becomes redundant in that kegs of beer may now be supplied to the system at room temperature. Beer may now be conveniently chilled at the point of sale to between 29° F. and 32° F. from kegs that are at room temperature. There is virtually no storage of beer in the system, hence there is no requirement for a beer reservoir.

### BRIEF DESCRIPTION OF THE DRAWINGS

FIG. 1 shows of a heat exchanger system of the prior art;

FIG. 2 shows a heat exchanger of this invention;

FIG. 3 shows a sectional view of this invention;

FIG. 4 shows a compact perspective of this invention;

FIG. 5 shows a sectional view of the apparatus of FIG. 4;

FIG. 6 shows a sectional view of the apparatus of FIG. 4 having a flow separation tube installed;

FIG. 7 shows the apparatus of FIG. 4 with a flow separation fin installed;

FIG. 8 shows an alternate form of this invention.

### DESCRIPTION OF THE PREFERRED EMBODIMENT

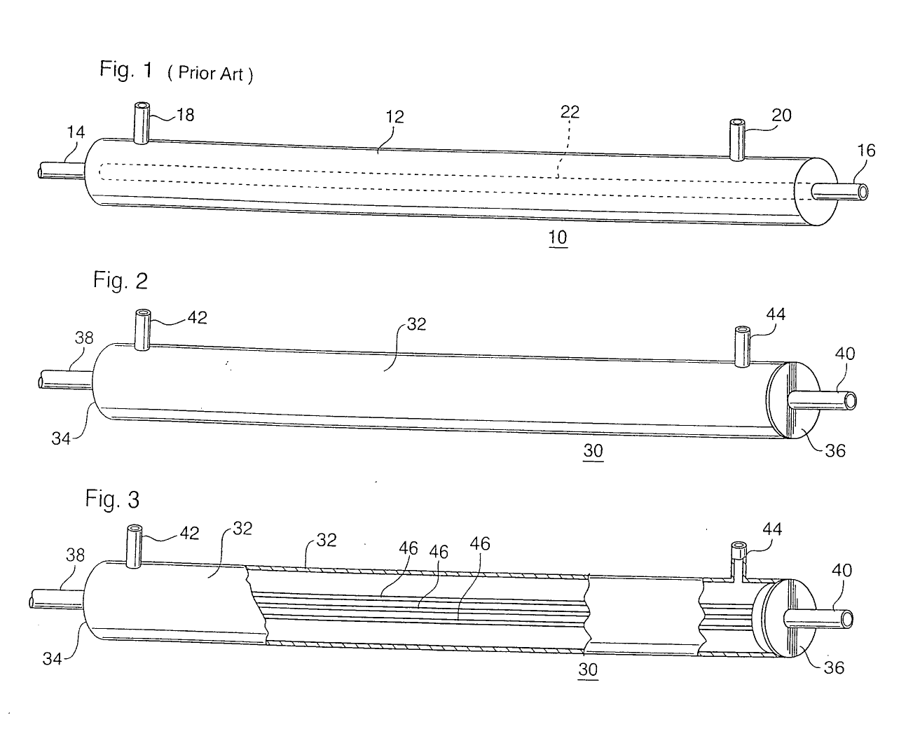

Referring now to FIG. 1, a heat exchanger 10 of the prior art is shown. The outer sheath or enclosure is shown as 12. A commercial installation involves a pipe, the ends of which are shown as 14 and 16 here are shown as a single pipe but the pipe shown as 22 may represent several beer carrying pipes, as long as pipe 22 is assumed to be carrying beer of different types. The heat exchanger 10 usually consists of an outer tube 12 in which a solution of heat exchanger fluid is circulated.

This is representative of a system as it existed before applicant's invention. Though spigots 18 and 20 are also shown projecting from points near the ends of pipe 12, the spigots 18 and 20 may emanate from a variety of locations on sheath or pipe 12. This represents a trunk line which extends from the storage room to the fountain. Thus the beer is maintained more or less at the temperature of the cold room while it is being transported by tube(s) 22 to the fountain.

Everything functions well until in this system until the demand for beer exceeds the ability to supply cold beer. Beer in tube or pipe 22 will be much colder at the inside surface of pipe 22 than it will be in the centre of pipe 22. This will lead to ice build up at the inside surface of pipe 22. If this situation continues to develop the restriction on the flow of beer in tube 22 leads to a slowing down in the flow of beer in pipe 22 and excessive frothing of the beer which generally leads to the eventual “freeze up” of the system. When this happens the operator has no other choice but to thaw out the entire system. This calls for the complete shut down of the system. When the system is re-established the operator seeks to avoid the previous problem and he does so by decreasing the diameter of the beer pipe 22 (to improve the cooling) and to compensate for this reduction in diameter, he must increase the pressure on the beer contained in the keg feeding beer to the system. This usually calls for the use of expensive“beer gas” to pressurize the system.

At times the addition of an accumulator (a reservoir) at the fountain was thought to ameliorate this problem but the solution was only worsened when situations of high demand for cold beer was encountered.

FIG. 2 is a perspective drawing of the heat transfer device of applicant's invention. Here, a heat exchanger is shown extending the entire length of pipe 32. Pipe 32 extends between ends 34 and 36 which are sealed into the pipe 32. A pair of spigots 38 and 40 are supported by the ends of pipe 32. These spigots are used to supply and deliver beer to the heat exchanger 30. Spigots 38 and 40 may be metallic in this instance. A pair of spigots 42 and 44 is sealedly connected near the ends 34 and 36 of the heat exchanger 30. This heat exchanger is of the same physical dimensions as shown in FIG. 1 and is designed to replace it.

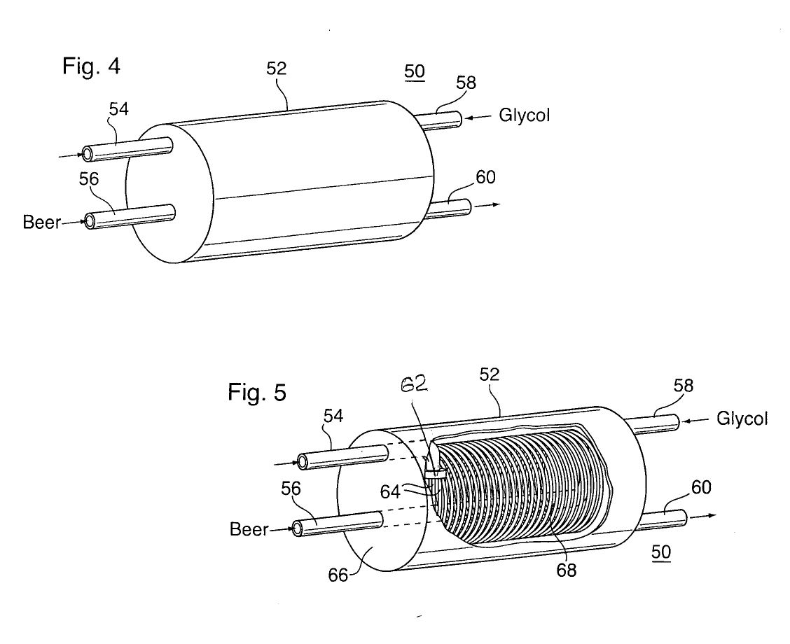

FIG. 3 shows the Heat Exchanger 30 of FIG. 2 in partial perspective. In this figure the spigots 38 and 40 are in fact manifolds for the inner tubes shown as 46 of applicant's heat exchanger 30. Here the manifolds 38 and 40 are shown located at the ends of the pipe 32.

The heat exchanger apparatus which is shown comprises a plurality of tubes 46. Tubes 46 of applicant's invention are preferably fabricated from stainless steel or some suitable metallic plastic substance and are in the order of 3/16 of an inch ID and are approximately 12 thousandths of an inch thick. The number of tubes required to accomplish the desired cooling of the beer flowing there through will vary, but it will generally be found that an arrangement of four to six stainless steel tubes (all carrying the same product) and extending about thirty feet (the length will vary with installation) and joined to a common manifold at each end of the pipe 32, will serve to supply cooled beer at a preselected temperature. The beer conduits 46 may be configured in any manner along their length in pipe 32 to increase the “scrubbing” effect of the cold heat transfer medium (usually glycol).

Spigot 44 which carries the cold glycol in the installation and it transfers the cold to the tube(s) 46 carrying beer. The heat exchange to the beer is quite good and has functioned satisfactorily.

FIG. 4 shows a perspective drawing of a compacted model of the applicant's invention. Here a heat exchanger 50 is shown folded about itself, yielding a more compact heat exchanger, having a container 52 providing suitable housing for its contents. At one end of container 52, a pair of tubes or pipes 54 and 56 is shown protruding therefrom. These pipes are carrying beer to and away from the heat exchanger 50 which is to be cooled during passage of beer there through.

At the opposite end of container 52 is a pair of pipes or tubes 58 and 60 which are carrying cold glycol to and away from the container 52. This provides cooling for beer.

It is not necessary that tubes 58 and 60 be at opposite ends of the container 52 as shown, the configuration of the tubes 58 and 60 and tubes 54 and 56 emanating from the container 52 matters little.

FIG. 5 shows a partial perspective (in section) of applicant's heat exchanger 50. Here all the pieces have the same reference numbers as those shown in FIG. 4 but the container 52 is shown partially in section to better illustrate applicant's invention. In this figure the single tube 54 is shown being connected to a plurality of tubes 64 at junction 62. Tube 56 passes through end 66 of container 52 and is connected to tubes 64 at the junction thereof (not shown).

Single tubes 54 and 56 are connected to the tubes at 62 of the heat exchanger 50 and actually serve as manifolds for the tubes 64.

Pipes 58 and 60 are located at the end 68 (not shown) of container 52 and pipe 58 carries cold glycol to the heat exchanger 50, and pipe 60 carries slightly warmed glycol from the heat exchanger 50 of this invention.

The compact heat exchanger 50 of this invention results from winding of tubes 64 (may comprise a multiplicity of parallely connected tubes) into a spiral coil and subsequently forming the tubes 64 into a cylinder and inserting them inside container 52. The tubes 64 will generally be representative of at least three separate layers of the heat tubes connected in parallel. This allows the heat exchanger 50 to be installed in locations previously thought to be impossible, but now because of its compactness, installation now becomes possible.

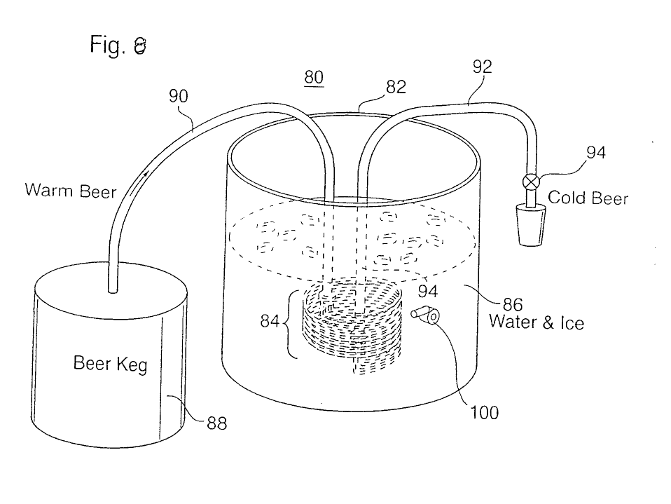

FIG. 6 shows the apparatus of FIG. 5 with a tube 70 (plastic or some other suitable substance) mounted therein to direct the cooling medium flow amongst the tubes shown as 68. Here flow directing tube 70 serves to direct the flow of the heat exchange medium onto the tubes 68 so that the tubes 68 (which will be formed by a multiplicity of tubes) of the heat exchanger 52 each will be exposed to the cold heat exchange medium while the heat exchange medium is at a much lower temperature than it would have been had not the tube 70 been present.

Tube 70 may be hollow as shown and as such may serve as the return path for the heat exchange medium (once it has been exposed to the tubes 68) if desired.

Tube 70 is comprised of materials selected from the following groups of materials: plastic, paper, neoprene etc.

FIG. 7 shows the apparatus of FIG. 5 with a fin 72 wound between tubes 68. Although only one turn of the fin 72 is shown it is to be understood that fin 72 is merely a representation of the complete finned structure in which fin 72 is wound is continuously, simultaneously with the coil structure as it is being wound and formed, so as to separate the tubes 68 from the adjacent hollow tubes.

The efficiency of the heat exchanger 52 is increased by the addition of a spirally wound separator 72 placed between the tubes 68 of the device 52. This may be a non-metallic plastic shield which assures that cold glycol is always exposed to the substance (beer) carrying coils 68.

FIG. 8 shows an installation 80 where a heat exchanger is installed in an open vessel 82. This will be the situation where the device 80 is used as a beer chiller at “tailgate” parties. Here a compact heat exchanger 84 (composed of several pipes connected in parallel similarly as shown in FIG. 3) is loosely supported by vessel 82 which contains a mixture of water and ice 86. Heat exchanger 84 is shown immersed in the mixture of ice and water 86. A beer keg 88 is shown outside vessel 82 and is connected to a compact heat exchanger 84 by means of tube or pipe 90. The other end of the heat exchanger 84 is connected to tube 92 which is connected to valve 94 of the substance (beer) dispensing apparatus.

An agitator is shown at 100 (which may be a pump) to make sure that there is a constant supply of the cold heat exchange medium to the heat exchanger 84. This assures that the product supplied to the customer is always cold.

The device of FIG. 6 uses water loaded with chunks of ice as the heat transfer medium. Water as is well known as a good heat transfer medium. Here it is important that when using the apparatus of FIG. 6 to cool the substance (beer) that the mixture of water and ice be agitated continuously to assure good heat transfer in the heat exchanger 50. Fins such as that shown as that shown as 72 in FIG. 7 will assist in cooling the circulated substance (beer)

The heat transfer medium of this invention may include any cooling medium from water to Freon®. It is seen that water carrying ice will function as a suitable heat transfer medium.

This apparatus will function to chill carbonated beverages where a syrup and water are mixed, which when served requires pressure to be applied to the mixed product as well.

There are important distinctions to be made of the apparatus described here:

1. A multiplicity of pipes carries the same product to the same destination in the heat exchangers shown in this invention.

3. The use of multiple tubes carrying the same product (beer) to the same destination results in apparatus that requires no increase in pressure applied to the product in order to deliver the product to its destination.

4. The glycol used in this invention is completely harmless when ingested by humans.

Many modifications and other embodiments of the invention will come to mind of one skilled in the art, having the benefit of the teachings presented in the foregoing description and the associated drawings. Therefore, it is to be understood that the invention is not to be limited to the specific embodiments disclosed, and that the modifications and embodiments are intended to be included within the scope of the dependent claims.

1. A heat exchanger for heating or cooling liquids comprising:
a flexible elongated pipe of predetermined length having a pair of end pieces sealed into each end to produce a sealed internal cavity therein,
a first pair of spigots sealed into said end pieces of said pipe,
each serving as a manifold for said heat exchanger, so that each end of the pipe has a spigot protruding therefrom which is in communication with and sealed to a set of metallic heat exchange tubes extending in said cavity between the ends of said pipe,
a heat exchange medium admitted to and exiting from the interior of said pipe via a second pair of spigots sealedly mounted in said elongated pipe.

2. A heat exchanger as claimed in claim 1 wherein a set of metallic heat exchange tubes is gently twisted along its length to form a single entity.

3. A heat exchanger as claimed in claim 1 wherein the number of metallic tubes in said heat transfer apparatus is greater than four.

4. A heat exchanger as claimed in claim 1 where the outside flexible pipe has an inside diameter of about ¾ of an inch.

5. A heat exchanger for heating or cooling fluids comprising:
a flexible elongated pipe of a predetermined length having a pair of sealed ends to produce a sealed interior cavity therein,
each end has at least two spigots protruding therefrom, one pair of which are sealedly connected to a plurality of separate sealed metallic heat exchange tubes extending in said cavity between the ends of said pipe,
a heat transfer medium admitted to and exiting from said cavity in the interior of said pipe via another pair of spigots sealedly mounted therein.

6. A heat exchanger as claimed in claim 5 wherein each set of metallic heat exchange tubes is gently twisted along its length to form a single entity.

7. A heat exchanger as claimed in claim 5 wherein the number of metallic tubes in each set is greater than three.

8. A heat exchanger as claimed in claim 5 wherein the outside flexible pipe has an inside diameter of about ¾ of an inch.

9. A heat exchanger for heating or cooling fluids comprising:
a vessel of a predetermined shape containing a heated or cooled liquid therein,
a metallic heat exchanger immersed in said liquid,
said metallic heat exchanger comprising at least two parallely connected hollow metal tubes of substantially the same diameter and length,
a liquid being introduced and flowing through said tubes of said heat exchanger, said liquid changing temperature as it flows through said heat exchanger.

10. A heat exchanger as claimed in claim 9 wherein said tubes are sealedly connected into two manifolds at the ends of said tubes.

11. A heat exchanger as claimed in claim 10 wherein said vessel is shaped into the form of a conduit of about the same length as said tubes and said manifolds are sealed into the ends of said conduit.

12. A heat exchanger for cooling a substance comprising a first pair of hollow tubes connected to a series of parallely connected hollow tubes wound in the form of a spiral coil,
said heat exchanger being surrounded by a suitable heat transfer medium so as to cool said series of parallely connected tubes of said heat exchanger,
circulating said substance through said hollow tubes of said heat exchanger.

13. A heat exchanger as claimed in claim 12 wherein the first two hollow tubes are connected to said series of parallely hollow tubes by means of a manifold connection.

14. A heat exchanger as claimed in claim 12 where said spiral coil surrounds a sleeve located at the centre thereof.

15. A heat exchanger as claimed in claim 12 wherein the substance is beer.

16. A heat exchanger as claimed in claim 13 wherein a deflector fin is wound into said spiral coil to separate said parallely connected hollow tubes of said heat exchanger.

17. The heat exchanger of claim 12 wherein the heat transfer medium is water and ice.

18. A method of constructing a heat exchanger device comprising:
supplying an elongated conduit having a pair of ends,
supplying a heat exchanger comprising a plurality of similar tubes in excess of one which are in communication together at the ends of said conduit, said heat exchanger tubes being of substantially the same length as said conduit,
sealing the ends of said tubes into the two end pieces and subsequently sealing said end pieces into said conduit so that said heat exchanger lies within said conduit, and
installing a set of pipe connectors sealingly into said conduit for circulating a heat exchange fluid within said conduit.
